(19) United States
(12) Patent Application Publication
(10) Pub. No.: US 2013/0346138 A1
(43) Pub. Date: Dec. 26, 2013

(54) CREATION OF PRODUCTION PROCESS WORKFLOW DIAGRAMS

(71) Applicant: Sudhendu Rai, Fairport, NY (US)

(72) Inventor: Sudhendu Rai, Fairport, NY (US)

(73) Assignee: XEROX CORPORATION, Norwalk, CT (US)

(21) Appl. No.: 13/533,500

(22) Filed: Jun. 26, 2012

(51) Int. Cl. G06Q 10/06; G06T 11/20

(52) U.S. Cl. 705/7.24

(57) ABSTRACT

A method and system for creating production process workflow diagrams are disclosed. The system stores a graphic representation of a production facility. When a user request for a workflow diagram is received, and the request includes a time frame, a route is determined between all resources having at least one time stamp that is within the time frame. The graphic representation of the facility may be displayed, along with a graphic representation of the determined route.

### BACKGROUND

In multistage manufacturing facilities, the final product may be fabricated over a number of steps. At the beginning of the process, material is introduced into the work flow and the resultant intermediate product may be modified in subsequent steps either by addition of other materials or by a variety of manufacturing processes. In single line facilities, each of the sequential manufacturing steps is performed by one or more processing resources that are physically located next to each other. As a result, the intermediate product of each step passes in a relatively uninterrupted fashion from one resource to the next in sequence.

Not all multistage manufacturing facilities can be configured for single line production. Facilities that produce multiple products may require different workflows for different products. For example, in a print shop environment, the resources required for producing a wire-bound volume from individual pages may be widely distributed within the print shop. In addition, resources required for producing other print shop products may be interspersed among the wire-binding resources. As a result, production time may be wasted in moving the intermediate products among the required resources.

Accordingly, it would be beneficial to provide systems and methods that provide solutions to this problem, and that may provide additional benefits.

### SUMMARY

In an embodiment, a method of creating a production process workflow diagram includes storing production job workflow data in a database. The job workflow data includes, for each job of a group of jobs, a job identifier, multiple resources, and at least one time stamp for each of the resources. Each resource is configured to execute at least one process. The method also may include storing, in a computer-readable memory, a graphic representation of a production facility. The graphic representation include each of the resources and a location for each of the resources. When an electronic device receives a user request for a workflow diagram, and the request includes a time frame, the electronic device may directly or indirectly access the database to retrieve a job identifier for a job that has at least one time stamp that is within the time frame. For the job associated with the retrieved job identifier, the electronic device may determine a route between all resources having at least one time stamp that is within the time frame. The method also may include displaying the graphic representation of the facility along with a graphic representation of the determined route.

Optionally, the database may include, for each job of the plurality of jobs, an event type associated with each of the at least one time stamp associated with each of the resources. The event type may be an or all of the following: an arrival, a process start, a process interrupt, a process restart, a process stop, and a completion. The graphic representation of the production facility may include an image of the production facility and/or an electronic model of the production facility.

Optionally, when determining the route the method may include: (i) for the job associated with the retrieved job identifier, obtaining a list of all resources having at least one time stamp within the time frame; (ii) ordering the list of resources by time stamp from an earliest time stamp to a latest time stamp; and (iii) determining a geometrical path according to the location of each of the resources in the ordered list of resources.

The method also may include, for at least one of the jobs, calculating an amount of time at least one resource is used based at least in part on the event type associated with the at least one time stamp associated with the at least one resource. In addition, the method may include minimizing the determined route of at least one job identifier by changing the location of at least one resource. If so, the graphic representation of the production facility may include the change in location of the at least one resource.

The method also may include accessing the database to retrieve at least a second job identifier for at least a second job that has at least one time stamp that is within the time frame. For the at least second job associated with the at least second retrieved job identifier, the electronic device may determine a route between all resources having at least one time stamp that is within the time frame. The method may then include displaying a graphical representation of the determined route for the at least second job along with the graphic representation of the facility and the graphical representation of the determined route. Optionally, each of the graphical representation of the determined route and the graphical representation of the determined route for the at least second job may be displayed in a unique color.

Any or all of the steps above may be implemented by a system that includes an electronic storage device configured to store a database, and an electronic device comprising a processor configured to execute computer instructions, a display, a user input device, and a tangible computer-readable memory configured to store computer instructions,

### BRIEF DESCRIPTION OF THE FIGURES

FIG. 1 illustrates an embodiment of a spaghetti diagram produced according to the method and system disclosed herein.

FIG. 2 illustrates an embodiment of a database that may be used to produce a spaghetti diagram according to the method and system disclosed herein.

FIG. 3 is a flow chart of a method for automated production of a spaghetti diagram according to one embodiment of the method disclosed herein.

FIG. 4 shows an example of an output from a workflow diagram toolkit.

FIG. 5 illustrates various elements of an electronic device that may be part of the system described in this document.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

For the purposes of this document, an “electronic device” refers to a device that includes a processor and tangible, computer-readable memory. The memory may contain programming instructions that, when executed by the processor, cause the device to perform one or more operations according to the programming instructions. Examples of electronic devices include personal computers, gaming systems, televisions, and portable electronic devices such as smartphones, personal digital assistants, cameras, tablet computers, laptop computers, media players and the like.

Many manufacturing facilities require a number of processes, sequentially executed, to fabricate a final product. In a single line facility, an initial work piece may be introduced to a first manufacturing resource at the beginning of a manufacturing job, and the work piece may be sequentially processed through a variety of steps by resources that are physically close to each other. As an example, a facility may be structured to prepare and paint metal objects after they have been cast. The metal object may first be cleaned of surface oils by solvents, the solvents may then be evaporated by a heating station, the cleaned object may have its surface chemically prepared for the paint, the paint may be applied in one or several layers, and the final painted object may be dried and/or sealed with a clear sealant. Such a facility may have the cleaner, heater, chemical preparation, and subsequent resources aligned together so that a single conveyor may transport the object from one resource to the next in the sequence.

In other facilities, the multiple resources required to manufacture the end product may not be located close to each other for any number of reasons. For example, a human operator may be required at some or all of the process steps, and the operators may require ample room to move during the process steps. Alternatively, some resources may be used in multiple manufacturing jobs, and cannot be placed close to all the resources associated with each of the different job types. For example, in a print shop, different types of binding jobs may require differing sets of resources. A wire binding job may require that pages have the binding holes punched in them, followed by the pages having their edges trimmed, and then the pages may be bound by the wire in a binding machine. Alternatively, some print jobs may require that the pages should be laminated before binding, or that substrates be cut before being assembled together, or that pages be folded before being placed in an envelope. In the example of the wire binding job, the hole punching device and the wire binding device may not be near the lamination device. In such a manufacturing facility, intermediates in the manufacturing process may require transport from one manufacturing resource to the next in sequence. The transportation of the intermediates from one resource to the next may introduce time waste and other inefficiencies in production. Therefore, a means to track the progress of the entire job from start to finish would be useful to determine inefficiencies and therefore suggest process or facility layout improvements.

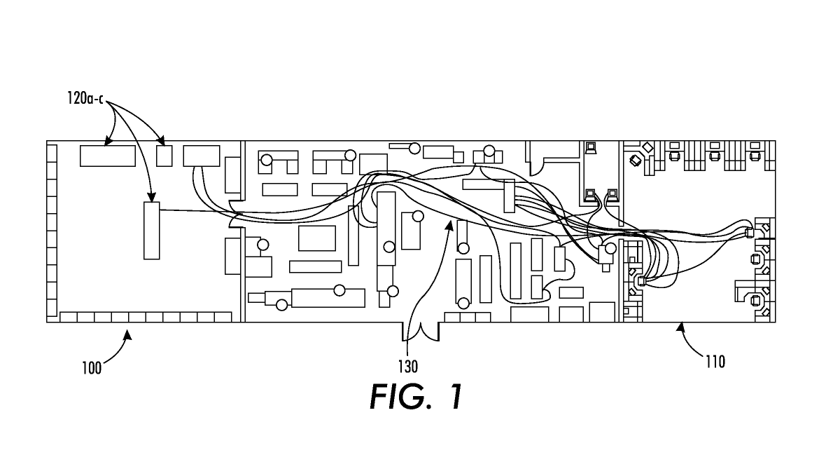

One method to track the movement of the intermediate products among the production resources in both time and space is a “spaghetti” or workflow diagram. The spaghetti diagram is a graphical representation of the motion of intermediates in a work flow for a particular job superimposed on a graphical representation of the locations of the resources within the production facility. Such a plot indicates both how the intermediates travel in the facility from one resource to another (in space) as well as the amount of time required for intermediate from one resource to the next resource in the process queue (in time). Typically, spaghetti diagrams are produced by hand. A base diagram of the production facility with the location of the resources may be produced by a typical computer aided design (CAD) software package. The flow of a job through the resources is then plotted by hand over the base diagram. A method to automate the production of spaghetti diagrams would increase their usefulness in terms of managing job scheduling, and provide means for process managers to consider improvements to the production flow. FIG. 1 illustrates an exemplary spaghetti diagram 100. The diagram may comprise two graphical representations: a graphical representation of the production facility, and a route between resources traversed by the materials during the job.

A first graphical representation may be one of the production facility 110. The production facility may be graphically represented in any of a variety of ways, including but not limited to a CAD representation, a blue-print, or a photograph of the facility. The graphical representation may include the location of rooms within the facility with their respective access points, such as doors or loading docks. The graphical representation may also include the location of manufacturing resources, exemplified by 120a-c, within the facility. The production facility graphic representation may be drawn to scale. The representations of the resources may include the amount of room occupied by just the resource (its footprint), or may include the resource footprint along with the amount of room around the resource that is required for an operator to work effectively. The graphic representations of the resources may include, without limitation, representations of machinery used to process intermediary products, space for storing materials used by the machinery, operator work surfaces, or other items commonly found in a production environment that may impede human traffic within the production facility.

A second graphical representation of the spaghetti diagram is a graph of the route taken by the product intermediary components among the resources used by the job 130. For each job, the route traces the workflow to and from each resource in successive order. The route should also be realistic in that it traces the path that a person carrying objects would have to move within the production facility, avoiding spaces occupied by resources, storage areas, and the like. Therefore, the path taken by the workflow route 130 should take into account the layout information of the graphic representation of the facility 110. The spaghetti chart can therefore provide a process manager a graphical representation of the progress of materials through the manufacturing facility.

Typically, a spaghetti diagram is created by hand, optionally using standard graphical design software. A designer may be provided the routing information associated with a particular job, and the designer may then use graphical tools which may be incorporated in a CAD drawing package to plot the route representing the job flow among the resources required to produce the finished product. Multiple jobs may be included into a spaghetti workflow diagram. For example, a production manager may wish to determine the flow path of all components of those jobs that occur during a specific timeframe, for example during a particular shift. The designer may then take the data associated with the workflow of all the jobs active during that time frame, and plot them together on the same spaghetti diagram, or separately on multiple diagrams. This may be time consuming. In addition, the time course data associated with the route taken for any one job may not be available for analysis in the final diagram. Further, the diagram may rely on a baseline representation of the facility that may be difficult to change. As a result, temporary changes in facility layout, such as changes required due to structural repairs that may force workers to traverse atypical paths between resources, may not be available for analysis.

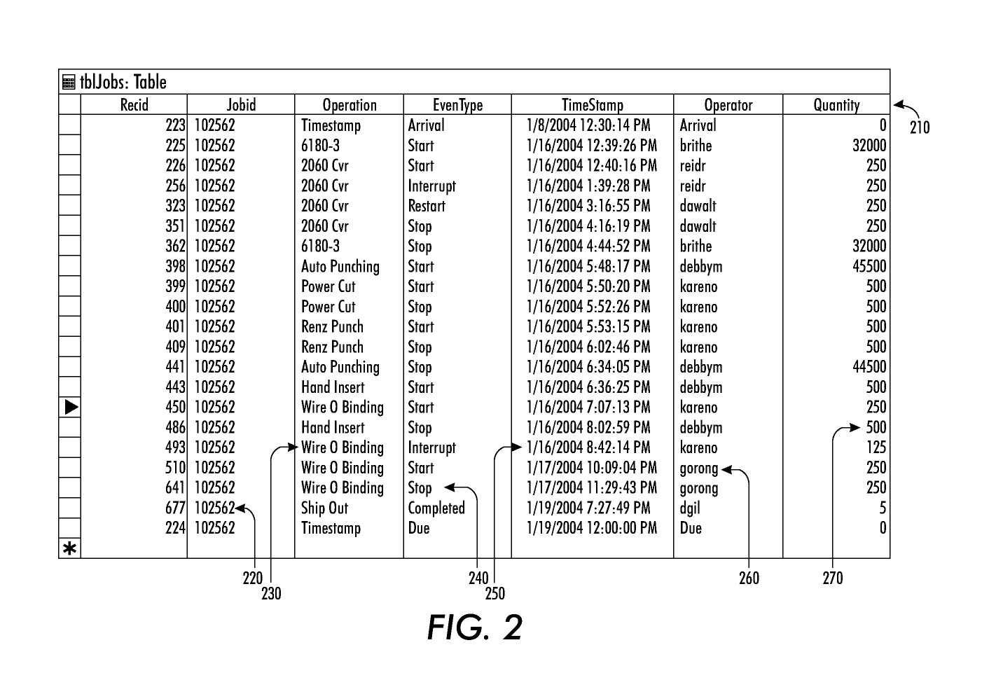

Disclosed below are a method and system for automating the development of a spaghetti diagram. The method and system rely on a database of information related to the workflow of a particular job. FIG. 2 illustrates a non-limiting example of information that may be included in such a database. The information in the database 200 may be organized in any of a number of formats as is known in the art. In one embodiment, the information in the database 200 may be formatted as a spreadsheet. The database may have entries related to any of a number of process categories 210. For example, the entries may include a job type, a specific job ID number 220, an identifier of an operation or process carried out by a specific resource 230, and a time stamp associated with the process carried out by the resource 250. A time-stamp data collection system or device may be used to track to movement of the part or parts associated with a specific job ID as it progresses through the workflow. Devices or systems to acquire the tracking data may include, as non-limiting examples, a barcode system or an RFID system. Each work piece associated with a specific job ID may be scanned for a barcode or RFID chip by an operator of a resource before the resource is used and after the operator is finished. The data acquisition system may produce a time-stamp record associated with the specific job ID and the resource used. This information may be included in the database.

In addition to the job ID, resource or operation data, and assigned time stamp, the database 200 may also include other information. In one embodiment, the time stamps may be labeled according to an event type 240. The event type may categorize the trigger event for the time stamp. In some non-limiting examples, an event type may include receipt of the incoming part or intermediate product at the resource, the start of the process, the completion of the process, and the transport of the work piece to the next resource. Other types of events may include a notice that the resource is non-functional, that the process is temporarily interrupted (for example when the resource operator leaves for the night), and that the process is restarted from an interruption (such as when the operator returns the following day). In other embodiments, other data in the database may include the name of a particular operator associated with a resource 260, or the number of items produced by a job 270 if it is a batch job. It should be understood that the database used for automated production of such workflow or spaghetti diagrams is not necessarily limited to the categories disclosed above, and that other data relevant to such a diagram or its analysis may incorporate more or fewer categories in alternative embodiments.

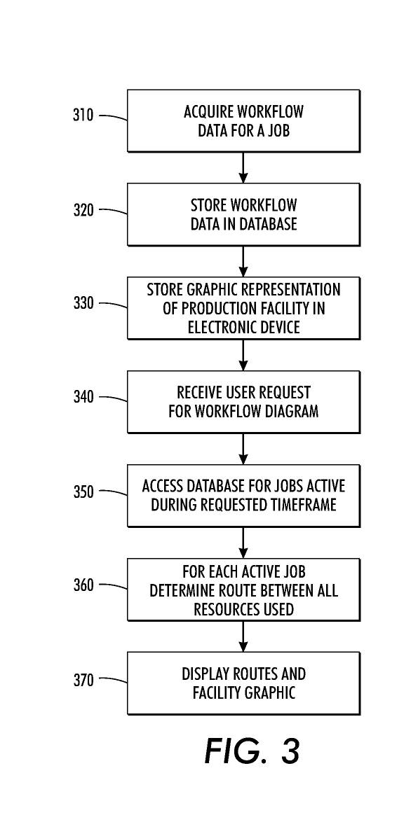

FIG. 3 is a flow chart of one embodiment of a method for automated production of a workflow spaghetti diagram.

Data related to the workflow of a particular job are acquired 310 according to methods disclosed above, including, without limitation, the use of barcode or radio frequency identification (RFID) readers located at individual resources. An operator at a resource may scan a barcode or RFID chip associated with the job work piece when it is received at the resource, at the time the work piece is being actively processed, or at other times before, during, or after the resource is used. In another embodiment, the operator may have a console or other electronic input device to log the resource use associated with the work piece. The operator may also have an operator ID badge that may be read by a badge reader to identify the operator. The data obtained from each resource operator may be given a time-stamp by a system-wide clock. The resulting data, including time stamp, may be stored in the workflow database 320 resident on an electronic storage device. The electronic storage device may include any device configured to store such data, including but not limited to removable storage drives, thumb drives, hard disk drives, read/write CD-ROMs, or similar devices.

A graphic representation of the production facility may be stored 330 in memory associated with an electronic device. This device may be the same as the device associated with the electronic storage device used to store the database information. The graphic information may also be stored on the same electronic storage device as the database, or may be stored in alternative storage device. The graphic representation of the production facility may be stored in any convenient format, including, without limitation, an image file, or as a file readable by a CAD program.

A user may then request a workflow diagram 340 comprising workflow routes superimposed on the representation of the production facility. In one embodiment, the user request may include a time frame that limits the information displayed by the workflow diagram to those jobs and resources active during the time frame. The time frame may include, without limitation, specified times, specified days, or specified work shifts. In another embodiment, the request may include specified job types or individual job IDs. In another embodiment, the request may include specified resources. The user may enter this request via a user input interface located on the electronic device storing the production facility graphic. Alternatively, the user may enter this request on a separate electronic device or computer that can relay the request to the electronic device. In one embodiment, the user input device may communicate directly with the database storage device and the device storing the facility graphic. In another embodiment, the user input device may communicate with a web server that can access the database and the facility graphic. In yet another embodiment, users at a number of individual user input devices may access the database storage device and the storage device of the facility graphic over a network.

In response to the user request, the database may be accessed to retrieve all data for processes, jobs, and/or resources active during the time frame 350. The determination of which resources are active during the time frame may be determined from the time stamps associated with each resource associated with a job. It is understood that only those resources active according to the time stamp may be accessed. Thus, only those data for resources active during the time frame for a job initiated before the start of the time frame will be retrieved. Similarly, only those data for resources active during the time frame for a job terminating after the end of the time frame will be retrieved. The data may be retrieved by the user input device, which as disclosed above, may be the same device that includes the database storage device, the electronic device that stores the facility graphic representation, or another input device.

Upon receipt of the database information, the route taken by the material(s) between the facility resources associated with each job may be determined 360. In one embodiment, the route associated with each job ID may be determined by ordering all the resources active during the time frame for each job by time stamp from earliest time to latest time, and then determining a geometric path from each resource to the next in the ordered list. The geometric path may be calculated based on the locations of the resources within the facility as provided on the facility graphical representation, using any now or hereafter known path determination methods. An example of a path generation process is described in Clarkson et al., “Rectilinear Shortest Paths Through Polygonal Obstacles in 0(n (log n)3/2) Time,” published by AT&T Bell Laboratories Feb. 15, 1995. Another approach is to store paths between different processing stations in the toolkit itself and then combine them at run-time to generate the spaghetti diagram.

It should be understood that the route determination calculation may be performed by any computer device programmed to carry out such calculations. Thus, the user input device may determine the route. Alternatively, any computer or device with such programmed capabilities and having access to the database and facility graphic representation may also calculate the route.

The spaghetti diagram comprising a graphical depiction of the determined route for each job along with the facility graphic may be displayed 370. The diagram may be displayed on a display associated with the user input device. In one embodiment, the user interface device may display the diagram from a web page accessed by the user interface device. In another embodiment, each job route may be displayed using a unique color or line style.

It is understood that a spaghetti diagram may incorporate additional features. For example, a diagram may provide a presentation of resource locations in a facility as well as a proposed change in location of at least one resource. The database data may then be used to determine if production time may be improved by relocating the resource. In another embodiment, the diagram may be used to highlight resources that are heavily used by multiple jobs types. In another embodiment, the amount of time a resource is used may be calculated from the time stamps. Information of this type may indicate that a duplicate of an overused resource may cut down on the overall production time at the facility.

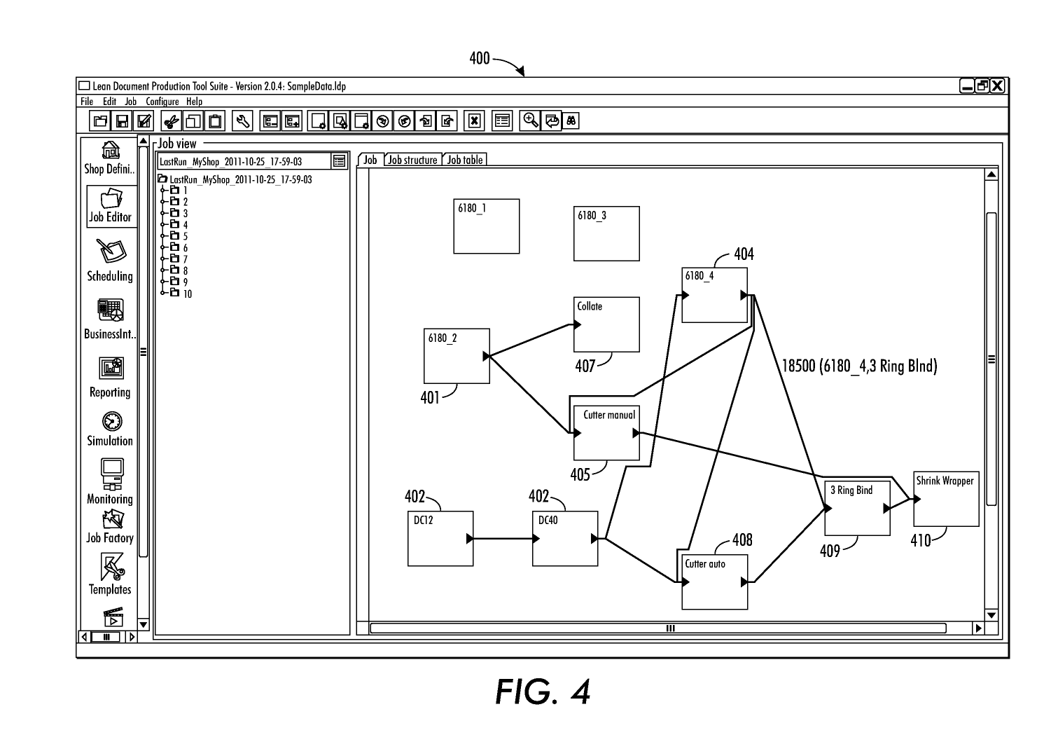

FIG. 4 illustrates an example graphical representation of a workflow 400 with elements of a production facility. As the diagram illustrates, various jobs may move between one or more printers 401-404 and a manual cutting station 405, a collating station 407, an automatic cutter 408, a 3-ring binding station 409, and a shrink wrap station 410.

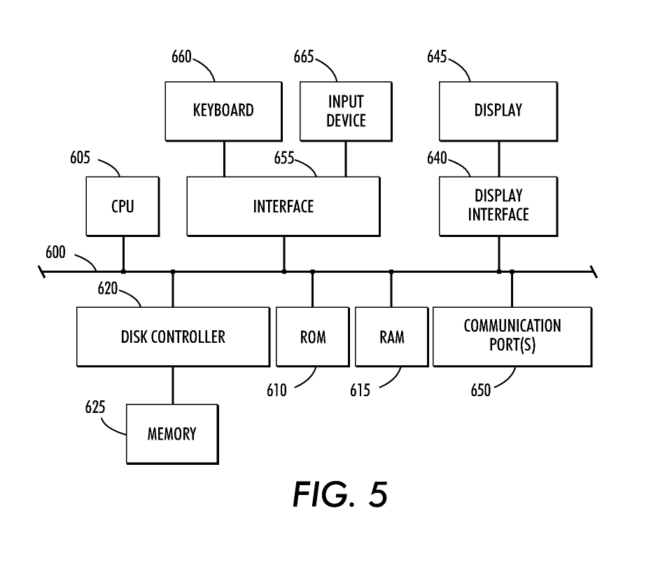

FIG. 5 depicts a block diagram of internal hardware that may be used to contain or implement the various services and processing devices as discussed above. A bus 600 serves as the main information highway interconnecting the other illustrated components of the hardware. CPU 605 is a processor, the central processing unit of the system that performs calculations and logic operations required to execute a program. CPU 605, alone or in conjunction with one or more of the other elements disclosed in FIG. 5, is a processing device, computing device or processor as such terms are used within this disclosure. Read only memory (ROM) 610 and random access memory (RAM) 615 constitute exemplary memory devices.

A controller 620 provides an interface between with one or more optional tangible, computer-readable memory devices 625 and the system bus 600. These memory devices 625 may include, for example, an external or internal DVD or CD ROM drive, a hard drive, flash memory, a USB drive or the like. As indicated previously, these various drives and controllers are optional devices. Additionally, the memory devices 625 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any the methods and systems as discussed above may be stored in the ROM 610 and/or the RAM 615. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 640 may permit information from the bus 600 to be displayed on the display 645 in audio, visual, graphic or alphanumeric format. The information may include information related to a current job ticket and associated tasks. Communication with external devices may occur using various communication ports 650. An exemplary communication port 650 may be attached to a communications network, such as the Internet or an local area network.

The hardware may also include an interface 655 which allows for receipt of data from input devices such as a keyboard 660 or other input device 665 such as a mouse, a joystick, a touch screen, a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method, comprising:
storing, in a database, production job workflow data, wherein the job workflow data comprises, for each job of a plurality of jobs, a job identifier, a plurality of resources, and at least one time stamp for each resource of the plurality of resources, wherein each resource is configured to execute at least one process;
storing, in a computer-readable memory, a graphic representation of a production facility, wherein the graphic representation comprises each resource of the plurality of resources and a location for each of the resources;
by an electronic device, receiving a user request for a workflow diagram, wherein the request includes a time frame;
by the electronic device, accessing the database to retrieve a job identifier for a job that has at least one time stamp that is within the time frame;
for the job associated with the retrieved job identifier, determining, by the electronic device, a route between all resources having at least one time stamp that is within the time frame, and creating a graphic representation of the determined route; and
displaying the graphic representation of the facility along with the graphic representation of the determined route.

2. The method of claim 1, wherein the database further comprises, for each job of the plurality of jobs, an event type associated with each of the at least one time stamp associated with each of the resources.

3. The method of claim 2, wherein the event type is one of the following event types: an arrival, a process start, a process interrupt, a process restart, a process stop, and a completion.

4. The method of claim 1, wherein the graphic representation of a production facility comprises either or both of an image of the production facility and an electronic model of the production facility.

5. The method of claim 1, wherein determining the route comprises:
for the job associated with the retrieved job identifier, obtaining a list of all resources having at least one time stamp within the time frame;
ordering the list of resources by time stamp from an earliest time stamp to a latest time stamp; and
determining a geometrical path according to the location of each of the resources in the ordered list of resources.

6. The method of claim 2, further comprising, for at least one job of the plurality of jobs, calculating an amount of time at least one resource is used based at least in part on the event type associated with the at least one time stamp associated with the at least one resource.

7. The method of claim 1, further comprising minimizing the determined route of at least one job identifier by changing the location of at least one resource.

8. The method of claim 7, wherein the graphic representation of the production facility includes the change in location of the at least one resource.

9. The method of claim 1, further comprising:
accessing the database to retrieve at least a second job identifier for at least a second job that has at least one time stamp that is within the time frame;
for the at least second job associated with the at least second retrieved job identifier, determining, by the electronic device, a route between all resources having at least one time stamp that is within the time frame, and creating a graphic representation of the determined route for the at least second job; and
displaying the graphical representation of the determined route for the at least second job along with the graphic representation of the facility and the graphical representation of the determined route.

10. The method of claim 9, wherein each of the graphical representation of the determined route and the graphical representation of the determined route for the at least second job is displayed in a unique color.

11. A system comprising:
an electronic storage device configured to store a database of production job workflow data, wherein the job workflow data comprises, for each job of a plurality of jobs, a job identifier, a plurality of resources, and at least one time stamp for each resource of the plurality of resources; and
an electronic device comprising a processor configured to execute computer instructions, a display, a user input device, and a tangible computer-readable memory configured to store computer instructions,
wherein the computer instructions direct the electronic device to:
receive a user request for a workflow diagram, wherein the request includes a time frame;
access the database to retrieve a job identifier for a job that has at least one time stamp that is within the time frame;
retrieve a graphic representation of a production facility, wherein the graphic representation comprises each resource of the plurality of resources and a location for each of the resources;
for the job associated with the retrieved job identifier, determine a route between all resources having at least one time stamp that is within the time frame and create a graphic representation of the determined route; and
display the graphic representation of the facility along with the graphic representation of the determined route.

12. The system of claim 11, wherein the database further comprises, for each job of the plurality of jobs, an event type associated with each of the at least one time stamp associated with each of the resources.

13. The system of claim 12, wherein the event type is one of the following event types: an arrival, a process start, a process interrupt, a process restart, a process stop, and a completion.

14. The system of claim 11, wherein the graphic representation of a production facility comprises either or both of an image of the production facility and an electronic model of the production facility.

15. The system of claim 11, wherein the computer instructions to determine the route comprise computer instructions to:
for the job associated with the job identifier, obtain a list of all resources having at least one time stamp within the time frame;
order the list of resources by time stamp from an earliest time stamp to a latest time stamp; and
determine a geometrical path according to the location of each of the resources in the ordered list of resources.

16. The system of claim 12, further comprising computer instructions, for at least one job of the plurality of jobs, to calculate an amount of time at least one resource is used based at least in part on the event type associated with the at least one time stamp associated with the at least one resource.

17. The system of claim 11, further comprising computer instructions to minimize the determined route of at least one job identifier by changing the location of at least one resource.

18. The system of claim 17, wherein the graphic representation of the production facility includes the change in location of the at least one resource.

19. The system of claim 11, further comprising computer instructions to:
access the database to retrieve at least a second job identifier for at least a second job that has at least one time stamp that is within the time frame;
for the at least second job associated with the at least second retrieved job identifier, determine, by the electronic device, a route between all resources having at least one time stamp that is within the time frame, and creating a graphical representation of the determined route for the at least second job; and
display the graphical representation of the determined route for the at least second job along with the graphic representation of the facility and the graphical representation of the determined route.

20. The system of claim 19, wherein each of the graphical representation of the determined route and the graphical representation of the determined route for the at least second job, is displayed in a unique color.
